(19) United States
(12) Patent Application Publication
(10) Pub. No.: US 2018/0336228 A1
(43) Pub. Date: Nov. 22, 2018

(54) AUTOMATED DATA INFRASTRUCTURE AND DATA DISCOVERY ARCHITECTURE

(71) Applicant: TimeXtender A/S, Aarhus V (DK)

(72) Inventor: Heine B. Krog Iverson, Tilst (DK)

(21) Appl. No.: 15/981,172

(22) Filed: May 16, 2018

Related U.S. Application Data
(60) Provisional application No. 62/507,645, filed on May 17, 2017.

(51) Int. Cl. G06F 17/30; G06F 17/27

(52) U.S. Cl. CPC G06F 17/30297; G06F 17/2705; G06F 17/30569; G06F 17/30952

(57) ABSTRACT

A system to generate a refined data structure may includes a parser to extract metadata from raw data from a group of data sources and to generate a metadata index distinctly stored on a metadata storage, the parser transforming the raw data into a group of distinct data containers in a core data storage distinct from the metadata storage. The system further includes a refinement infrastructure reading the data containers and the metadata index and executing orchestration logic and schema optimization logic on contents of the data containers and the metadata index to generate the refined data structure.

### CROSS-REFERENCE TO RELATED APPLICATIONS

This application claims benefit under 35 U.S.C. 119 to U.S. application Ser. No. 62/507,645, filed on May 17, 2017, which is incorporated herein by reference in its entirety.

### BACKGROUND

Data is flooding into companies at an unprecedented rate. Typical sources of data including a company's operational systems (e.g., Enterprise Resource Planning/ERP such as Microsoft Dynamics, Oracle EBS, SAP; Customer Relationship Management/CRM such as Salesforce, PipelineDeals; Hospital Management Systems such as Epic, Cerner; analytics Systems such as Google Analytics; Marketing Automation Software such as Hubspot; and countless other operational systems), datasets (e.g., one or more files, generated by the company or generated by another company and provided to the company), data streams (e.g., data continuously output from sensors and Internet of Things/IOT data), and other sources of data that presently exist or will exist in the future. This data may be refreshed continuously or periodically, may be large in size, and may have different structures (e.g., structured databases, JSON/XML files, video and/or audio files, combinations of the above, etc).

These large data sources 110 are growing in terms of volume, velocity, and variety at a significant rate, and they are continuously changing (e.g., growing with new records or entities being added to the large data sources 110 as well as schema changes to the structure and/or metadata associated with the data). Companies are struggling to manage the ingestion of data to and from these large data sources 110, and are further struggling get data to their business users in a time-frame and a format that is optimized for business users to perform business operations with the data (e.g., business reporting, data visualization, machine learning, etc).

A common approach to accessing data for business intelligence may be classified as direct access. For example, referring to FIG. 1, assume a company has three large data sources 110 (data source 102, data source 104, data source 106) where at least one of these large data sources 110 is structured data and at least one of is semi-structured or unstructured data. Each of these large data sources 110 may have data that is usable by people in different departments within the company (e.g., a sales department 108, a finance department 112, and a marketing department 114.) But granting direct access to each employee to each data source is undesirable for several reasons: 1) it is complex for the business users (different large data sources 110 can be located in different physical and virtual locations and may be on different data platforms having different querying syntax); it creates administrative problems for the IT management team when they need to transition to a new data source (e.g., ERP upgrade), because every connection from every business user/business application to every data source must be updated; and it creates a performance load on the operational data sources (e.g., if a business user performs a complex query on an operational data source, it can slow down or even make the operational data system non-responsive for its operational requirements). These and other problems exist with direct access to data sources.

One approach to resolving the problems associated with direct access to data is to create a centralized repository that stores all of the data needed by the business for business intelligence operations. Two popular approaches for managing centralized data are a Data Warehouse (or Enterprise Data Warehouse) and a Data Lake. A data warehouse is a high-performance and highly structured database optimized for data analysis and reporting. Two challenges that customers may experience with a data warehouse include a lengthy build phase (e.g., it can take months to plan and implement) and a complex change process (e.g., as changes to the large data sources 110 occur, such as new data sources, or structural changes within a data source, it can take weeks or months for these changes to become available to the business users).

Data Lakes are being used as a low-cost solution to store vast quantities of data. Data lakes store data in a structure approximates its original state (e.g., the state of the data as it exits in large data sources 110), meaning that semi-structured data will be stored in a semi-structured state. Structure is applied using a “Schema on Read” approach on the data at read time, such as when a report or visualization is being generated. Schema on read has two primary benefits: more of the original source data is retained; and it takes less time to set up. The disadvantage to this methodology is that creating the schema at read time can be a complex task that requires special expertise and/or specialized tools for data analysis. These and other disadvantages make existing solutions unacceptable.

### BRIEF SUMMARY

Operational Data Exchange (ODX) is a massive scale data repository that leverages metadata to move data from large data sources 110 to a massive scale data repository and provision a subset of this moved data to structured data repository that is more accessible to business users. By connecting to a set of large data sources 110 of potentially varied structure, such as structured databases (e.g., SQL databases), flat files (e.g., comma separated or tab separated files), hierarchically structured data files (e.g., JSON and XML files), raw data files (e.g., audio, video, image files), and/or other data source structures, ODX extracts metadata through a variety of metadata extraction operations, stores this metadata in metadata storage, and leverages this metadata to provision data having variable data profiles (data structure and data volume). In a preferred embodiment, ODX moves data from large data sources 110 to core data storage, and then transforms this data from core data storage to a refined data storage. Core data storage may be a type of Hadoop Distributed File System (HDFS) or file-based system, such as Azure Data Lake, Hadoop, Amazon S3, Azure Blob Storage, or other type of storage. Refined data storage may be a type of Structured Query Language (SQL) data repository, such as Microsoft SQL Server or Microsoft SQL Database, Azure Data Warehouse, Amazon Redshift, Oracle Database, Terradata, MySQL, or other SQL-based or similar server/service.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a common approach to accessing data for business intelligence through complex data flows 100 between large data sources 110.

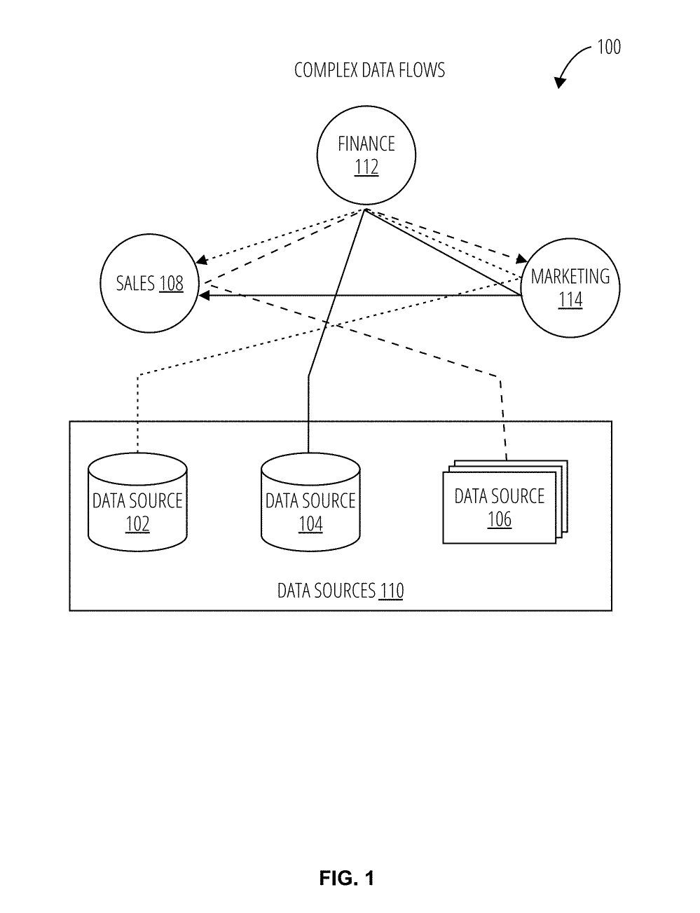

FIG. 2 illustrates an embodiment of a system for automating data infrastructure 200.

FIG. 3 illustrates an embodiment of a method of automating data infrastructure 300.

FIG. 4 illustrates an embodiment of a method for automating data movement and infrastructure 400.

FIG. 5 illustrates an embodiment of a method 500 for specifying a delivery time for data and creating or modifying the data infrastructure hardware and software to meet this delivery time requirement.

FIG. 6 illustrates an embodiment of a system for automating data movement and infrastructure 600.

FIG. 7 illustrates a sequence diagram for a system 700 in accordance with one embodiment.

FIG. 8 illustrates a method 800 for operating a system for automating data movement and infrastructure in accordance with one embodiment.

FIG. 9 illustrates a method 900 in accordance with one embodiment.

FIG. 10 illustrates a method 1000 in accordance with one embodiment.

FIG. 11 illustrates a method 1100 in accordance with one embodiment.

FIG. 12 illustrates a refinement engine user interface 1200 in accordance with one embodiment.

FIG. 13 illustrates a refinement engine user interface 1200 in accordance with one embodiment.

FIG. 14 illustrates a refinement engine user interface 1200 in accordance with one embodiment.

FIG. 15 illustrates a refinement engine user interface 1200 in accordance with one embodiment.

FIG. 16 illustrates a refinement engine user interface 1200 in accordance with one embodiment.

FIG. 17 illustrates a refinement engine user interface 1200 in accordance with one embodiment.

FIG. 18 illustrates a refinement engine user interface 1200 in accordance with one embodiment.

FIG. 19 illustrates a refinement engine user interface 1200 in accordance with one embodiment.

FIG. 20 illustrates a system 2000 in accordance with one embodiment.

FIG. 21 illustrates a computing device 2100 in accordance with one embodiment.

### DETAILED DESCRIPTION

Terminology used herein should be accorded its ordinary meaning in the art unless otherwise indicated expressly or by context.

“Engine” herein refers to logic or collection of logic modules working together to perform fixed operations on a set of inputs to generate a defined output. For example, IF (engine.logic {get.data( ),process.data( ),store.data( ),} get.data(input1)->data.input1; process.data(data.input1)->formatted.data1->store.data(formatted.data1). A characteristic of some logic engines is the use of metadata that provides models of the real data that the engine processes. logic modules pass data to the engine, and the engine uses its metadata models to transform the data into a different state.

“Raw data” herein refers to unprocessed information (e.g., numbers, instrument readings, figures, etc.) collected from a source. The raw data may contain some data structure or format generated by its source. For example, raw data may include information in comma separated values (.csv) delimiter separated values (.dsv), tab separated values (.tsv), etc.,

“Selector” herein refers to a logic element that selects one of two or more inputs to its output as determined by one or more selection controls. Examples of hardware selectors are multiplexers and demultiplexers. An example software or firmware selector is: if (selection_control==true) output =input1; else output=input2; Many other examples of selectors will be evident to those of skill in the art, without undo experimentation.

“Data containers” herein refers to a logic object implemented as a class, a data structure, or an abstract data type (ADT) whose instances are collections of other objects. Data containers serve as named areas of storage for logic objects. The size of the container depends on the number of objects (elements) it contains. They provide simple organization for accessing objects. For example, data containers may store files of raw data (e.g., .csv, .dsv, .tsv, etc.,) as logic objects and where the information stored within the object may only be accessed after the object has been retrieved and accessed.

“Parser” herein refers to logic that divides an amalgamated input sequence or structure into multiple individual elements. Example hardware parsers are packet header parsers in network routers and switches. An example software or firmware parser is: aFields=split(“val1, val2, val3”, “,”); Another example of a software or firmware parser is: readFromSensor gpsCoordinate; x_pos=gpsCoordinate.x; y_pos=gpsCoordinate.y; z_pos=gpsCoordinate.z; Other examples of parsers will be readily apparent to those of skill in the art, without undo experimentation.

“Schema optimization logic” herein refers to logic to evaluate the complexity of a database schema and object model based on performance with regards to handling queries and performing database tasks (e.g., joining tables, creating new table from fields of multiple other tables, change or create indexes for existing tables, deployment speed, target retrieval speed, query success, etc.,) and modifying the database schema and object model based on submitted queries to the database and/or to similar databases, and/or database schemas and objects models from similar better performing databases.

“Allocator” herein refers to logic to store data within a memory structure in accordance with a preconfigured object model or schema structure. For example, the allocator may receive a column of data values from raw data and may select to distribute the values to particular locations within the memory structure based on the preconfigured schema structure and/or the data value. For example, IF (field.data1=column1.data>“1.0”) column1.data{data1: “0.5”, data2: “1.4”, data3: “2.4”}=field.data1 {data2: “1.4”, data3: “2.4”).

“Correlator” herein refers to a logic element that identifies a configured association between its inputs. One examples of a correlator is a lookup table (LUT) configured in software or firmware. Correlators may be implemented as relational databases. An example LUT correlator is: |low_alarm_condition|low_threshold_value|0 ||safe_condition_|safe_|lower_bound |safe_upper_bound||high_alarm_condition|high_threshold_value|0 |Generally, a correlator receives two or more inputs and produces an output indicative of a mutual relationship or connection between the inputs. Examples of correlators that do not use LUTs include any of a broad class of statistical correlators that identify dependence between input variables, often the extent to which two input variables have a linear relationship with each other. One commonly used statistical correlator is one that computes Pearson's product-moment coefficient for two input variables (e.g., two digital or analog input signals). Other well-known correlators compute a distance correlation, Spearman's rank correlation, a randomized dependence correlation, and Kendall's rank correlation. Many other examples of correlators will be evident to those of skill in the art, without undo experimentation.

“Processed data” herein refers to information that has been modified, reorganized, converted, validated, sorted, summarized, aggregated, or manipulated from its original source to produce additional meaning than previously presented. For example. information extracted from an original source may be entered into a table with other information establishing a meaningful relationship between the previously stored data and the newly entered data.

While aspects of the present subject matter described herein have been shown and described, it will be apparent to those skilled in the art that, based upon the teachings herein, changes and modifications may be made without departing from the subject matter described herein and its broader aspects and, therefore, any claims are to encompass within their scope all such changes and modifications as are within the true spirit and scope of the subject matter described herein.

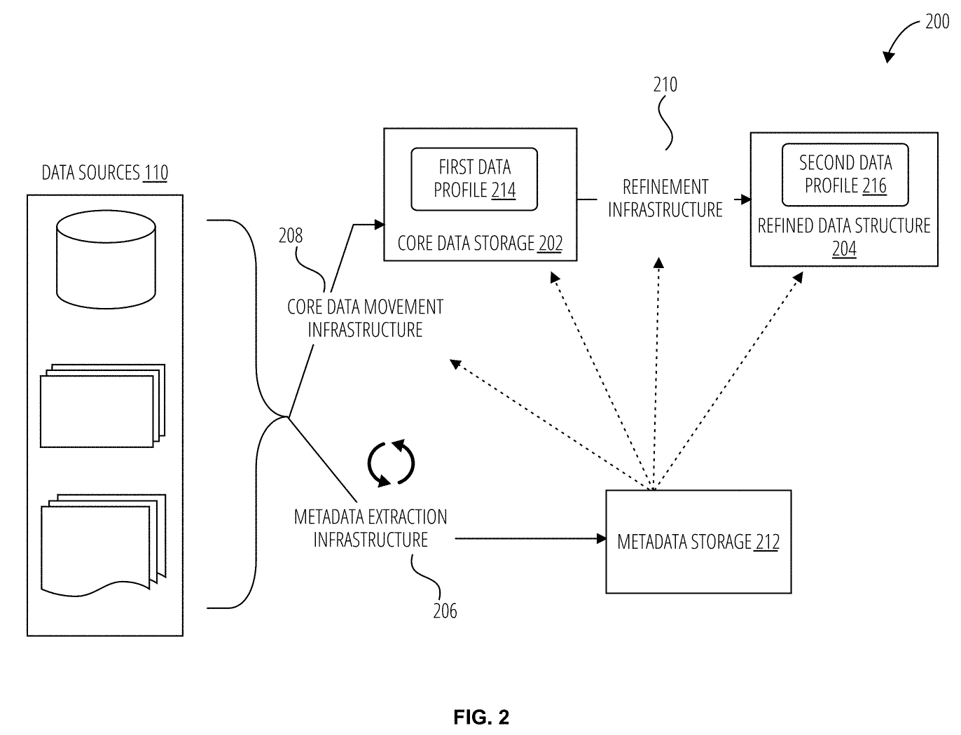

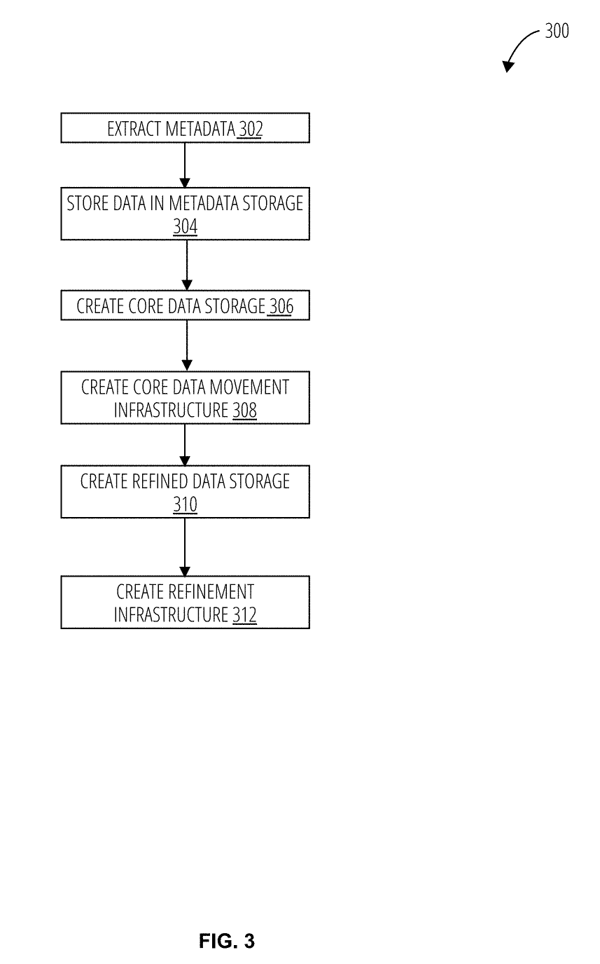

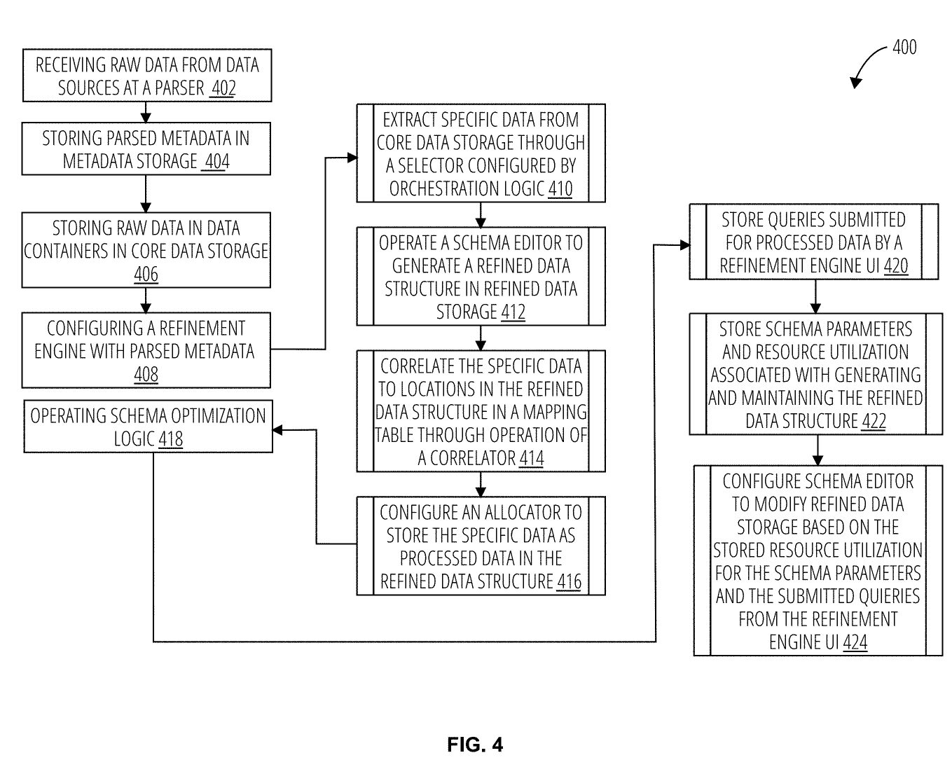

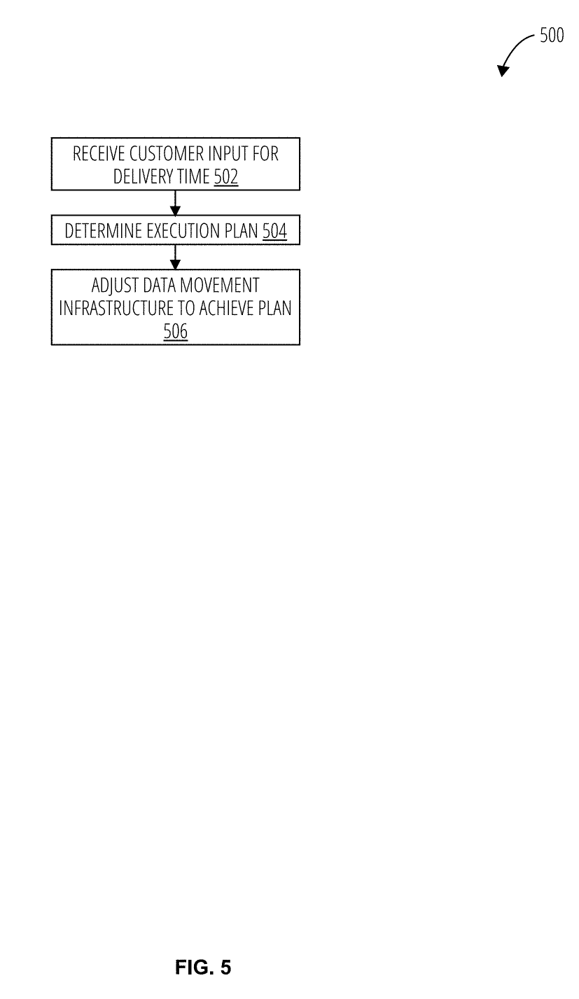

FIG. 2 illustrates an embodiment of a system for automating data infrastructure 200. The system for automating data infrastructure 200 shows large data sources 110 on the left. Metadata extraction infrastructure 206 extracts metadata from the large data sources 110 and stores the metadata in metadata storage 212. The metadata in metadata storage 212 is used to create core data movement infrastructure 208, core data storage 202, refinement infrastructure 210, and refined data structure 204, as further described in FIG. 3, FIG. 4, and FIG. 5. Data Storage can be characterized by a data profile that includes the volume of data and the structure of data within the data store. In a preferred embodiment, core data storage 202 has a first data profile 214 and refined data structure 204 has a second data profile 216 that is different than first data profile 214 (e.g., the volume and/or structure of data is different between core data storage and refined data storage.) The core data movement infrastructure 208 and the refinement infrastructure 210 moves data into and out of core data storage 202 and refined data structure 204, and handles on-premise/private cloud, shared/public cloud, and movement across other types of network environments. Core data storage 202 and core data movement infrastructure 208 may be created partially or entirely automatically, may be created by patterns or selections specified by a user, may be created by a combination of these approaches, and by other approaches. In one embodiment, core data storage 202 is a data lake accessible by a first set of users (e.g., data scientists, IT), and refined data storage is a SQL data source accessible by a second set of users (e.g., business analysts, business users).

FIG. 3 shows a method of automating data infrastructure 300. The method starts with extracting metadata (block 302). In block 302, extracting metadata may be performed in any manner suitable for gathering metadata about the data sources. Specific techniques that may be provided by ODX include: reading metadata from an API provided by the data store (e.g., reading Information_Schema.Columns from SQL Server, invoking GetOleDbSchemaTable from C# OleDB, etc.), learning metadata by observing directly or indirectly customer-provided metadata over time (e.g., if a customer creates a relationship between a parent and a child table, adds a text label to a field, specifies a particular data type for a field, etc), receiving metadata from an administrator, and generating metadata by reviewing attributes of the data (e.g., by using a combination of software and/or hardware to identify the type of data in some or all of the rows for a particular field).

Once the extract metadata in block 302 is complete, the metadata is stored in metadata storage (block 304). In block 304, metadata storage may be an SQL or another type of data repository. In one embodiment, metadata storage is a SQL Database that includes a table for each of: Customers, Databases, Columns, and Relationships. More or less metadata could be captured. In one embodiment, metadata from several companies may be stored in centralized metadata storage to enable analysis of the metadata across different companies.

Once the metadata is stored in block 304, the metadata can be used by software and/or hardware to create core data storage (block 306). In one embodiment, core data storage is a Data Lake. In addition to creating the Data Lake, permissions may be granted to the Data Lake (e.g., permissions granted to an existing or newly created Service Principal). Alternatively, core data storage may exist prior to extracting metadata, and credentials for/information about core data storage may be provided to ODX in advance of starting the method of automating data infrastructure without departing from the scope of the present invention.

In block 308, the method of automating data infrastructure 300 creates core data movement infrastructure to get data from large data sources 110 to core data storage. In a preferred embodiment, Core Data Movement Infrastructure moves data from Data Source to core data storage 202 on a periodic basis (e.g., daily, hourly, etc). Additionally, core data movement infrastructure 208 may move data incrementally, meaning that only new or newly modified data will be moved during each update period. This incrementally updated data may be placed in a file folder associated with the period, so that all of the data from one incremental load will be contained in a single folder. Date fields may be used as default incremental candidates, and various approaches may be used to eliminate an incremental candidate from use as an incremental candidate. For example, a user may specify that a particular field should not be used by ODX as an incremental field, or the data may indicate that a field is not suitable as an incremental candidate (e.g., because data stored in a date field corresponds to a time that is in the future). In a preferred embodiment, core data movement infrastructure 208 may include software and hardware infrastructure associated with Microsoft's Azure Data Factory, although other suitable software and hardware may be used (e.g., Amazon's cloud infrastructure, private or public data center hardware and software, Microsoft's Integration Services/SSIS software, or ETL and/or Data Virtualization software from Informatica, Alteryx, and other vendors).

ODX may then create refined data structure 204 (block 310). A refined data structure 204 (and its associated refinement infrastructure 210, described below) may be created partially or entirely automatically, may be created by patterns or selections specified by a user, may be created by a combination of these approaches, and by other approaches. Refined data structure 204 may be a subset of the data in core data storage 202, in terms of volume of data for a specified set of data sources (e.g., the volume of data in refined data storage for a given set of large data sources 110 is less than the volume of data in core data storage for this same set of large data sources 110), in terms of number of selected data sources (e.g., at least one data source and/or one element of a data source, such as a database, table, column, entity type, etc., that is present in core data storage is not present in refined data storage), in terms of a combination of both volume of data and number of selected data sources, and other manner of including a subset of the data from core data storage to refined data structure 204.

In one embodiment, refined data structure 204 may be an SQL Database. For source data extracted from SQL data sources, the refined data storage may have a similar structure to the source data (although it may include less than all of the data in the core data storage and the Data Source). For source data extracted from non-relational sources, transformation may be applied to the data in order to get it into a structure suitable for refined data storage. For example, hierarchical data may be transformed into a flattened structure (e.g., converted into a single table), it may be transformed into one or more parent and child tables with relationships (e.g., the parent nodes are moved into a parent table, and the child nodes are moved into a child table), or otherwise transformed so as to be readily usable as part of the refined data storage.

In one embodiment, refined data storage may be created by other logic, such as Data Warehouse Automation (DWA) software. DWA may request metadata from the metadata repository (e.g., available data sources 110), and a user and/or software application and/or template may select data structures to create in refined data structure 204. In one embodiment, DWA or other system may notify ODX of selected large data sources 110 and/or elements of large data sources 110 that will be provisioned in the refined data storage, so that ODX may create/manage the refinement infrastructure 210 into the appropriate refined data structure 204.

Finally, in block 312, refinement infrastructure 210, gets data from core data storage to refined data storage. In a preferred embodiment, refinement infrastructure 210 moves data from core data storage to refined data structure 204 on a periodic basis (e.g., daily, hourly, etc), and typically at the same interval as core data movement infrastructure 208. Additionally, refinement infrastructure 210 may move data incrementally, meaning that only new or newly modified data will be moved during each update period. This incrementally updated data may be pulled from the core data storage folder associated with the incremental period. Although a preferred embodiment of ODX includes data movement from data sources 110 to core data storage to refined data storage, other data movement approaches may be used including moving data in parallel from data sources 110 to both core data storage and refined data storage, moving data from data sources 110 to refined data structure 204 and then core data storage 202, and other data movement techniques.

Referencing FIG. 4, a method for automating data movement and infrastructure 400 involves receiving raw data from data sources at a parser (block 402). In block 404, the method for automating data movement and infrastructure 400 operates metadata extraction infrastructure and stores the parsed metadata in a core data metadata index in metadata storage. In block 406, the method for automating data movement and infrastructure 400 operates core data movement infrastructure and stores raw data in data containers within core data storage. In block 408, the method for automating data movement and infrastructure 400 configures a refinement engine with parsed metadata. In subroutine block 410, the refinement engine extracts specific data from core data storage through a selector configured by orchestration logic. In subroutine block 412, the data refinement engine operates a schema editor to generate a refined data structure 204 in refined data storage. In subroutine block 414, the refinement engine correlates the specific data to locations in the refined data structure in a mapping table through operation of a correlator. In subroutine block 416, the refinement engine configures an allocator to store the specific data as processed data in the refined data structure. In block 418, the method for automating data movement and infrastructure 400 operates schema optimization logic. In subroutine block 420, the schema optimization logic stores queries submitted for processed data by a refinement engine UI. In subroutine block 422, the schema optimization logic stores schema parameters and resource utilization associated with generating and maintaining the refined data structure. In subroutine block 424, the schema optimization logic configures the schema editor to modify refined data storage based on the stored resource utilization for the schema parameters and the submitted queries from the refinement engine UI.

Turning to FIG. 5, a method 500 for specifying a delivery time for data and creating or modifying the data infrastructure hardware and software to meet this delivery time requirement is described in a flow chart. One of the capabilities that the ODX architecture enables is to specify a delivery time for data and create or modify the data infrastructure hardware and software to meet this delivery time requirement. This capability allows ODX to meet a delivery time requirement even when environmental conditions are constantly changing (e.g., data volumes are growing, network latency changes, load on a data store increases). In a preferred embodiment, ODX receives customer input that specifies a delivery time (block 502). In block 504, the ODX may determine an execution plan based on one or more of: specified parameters, parameters calculated based on the characteristics of the data and hardware/software environment (e.g., how large is the data, characteristics of the data source and destination), parameters calculated based on observations of data movement time frames that have previously occurred, combinations of the above, and other techniques. Once the execution plan has been determined, ODX creates and/or updates the automated data infrastructure to deliver the data in accordance with the plan, and to meet the specified delivery time (block 506). By way of specific example, ODX may determine that it will take 50 minutes to move data from a data source core data storage and then to refined data storage, so if the specified delivery time is 8 AM PST, ODX can create Core Data Movement Infrastructure so that it initiates an initial pull from the data source at 7:10 AM PST. ODX may integrate additional capabilities, such as probabilities of completion (e.g., a 95% delivery time), buffers (e.g., allow 10% more than the calculated time to ensure timely delivery), and other capabilities.

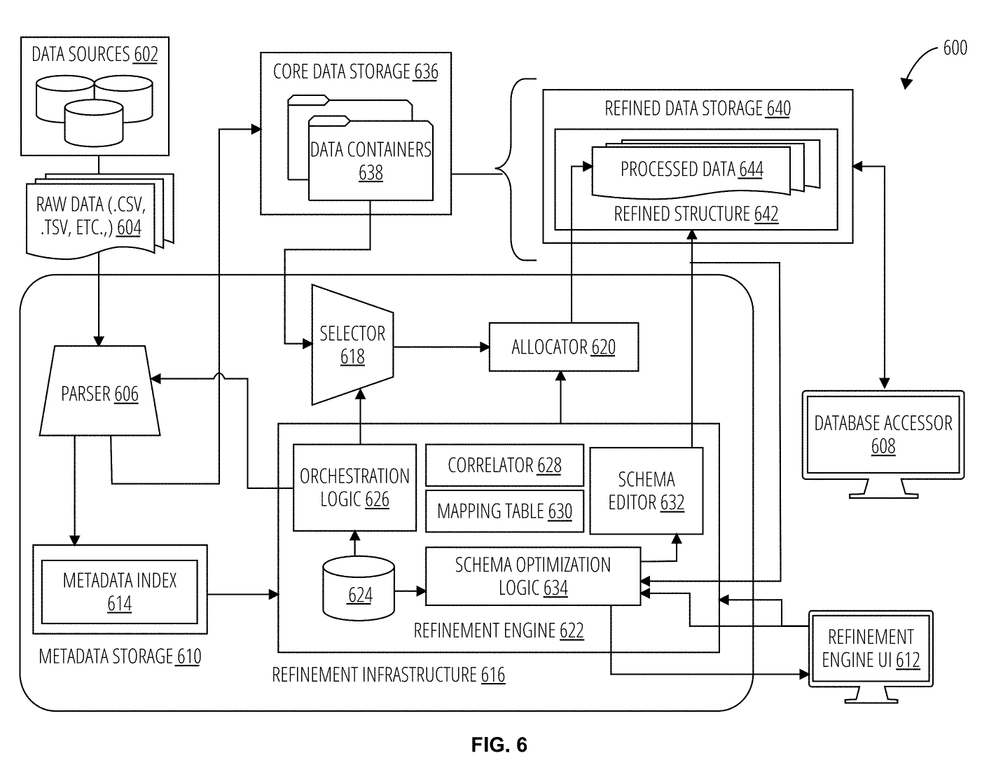

Referencing FIG. 6, a system for automating data movement and infrastructure 600 comprises data sources 602 with raw data 604, a parser 606, database accessor 608, a refinement engine UI 612, metadata storage 610 comprising a metadata index 614, a refinement infrastructure 616 comprising a selector 618, an allocator 620, and refinement engine 622, core data storage 636 comprising data containers 638 for the raw data, refined data storage 640 comprising refined data structure 642 with processed data 644. The refinement engine 622 comprises a global management infrastructure database 624, orchestration logic 626, a correlator 628, a mapping table 630, a schema editor 632, and schema optimization logic 634.

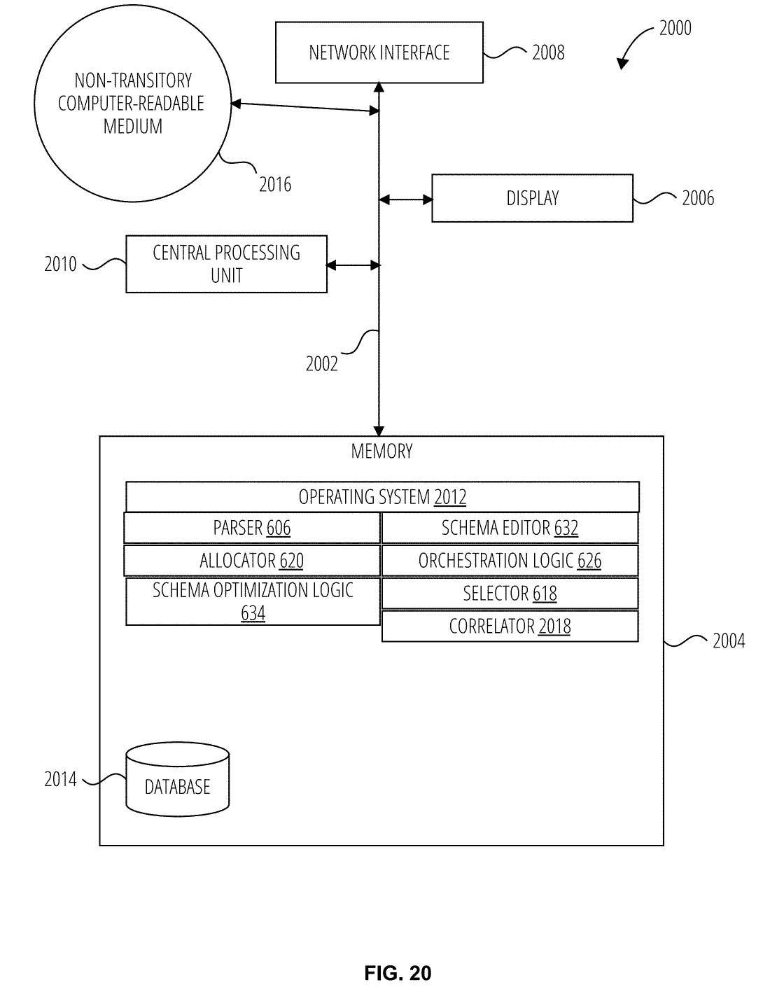

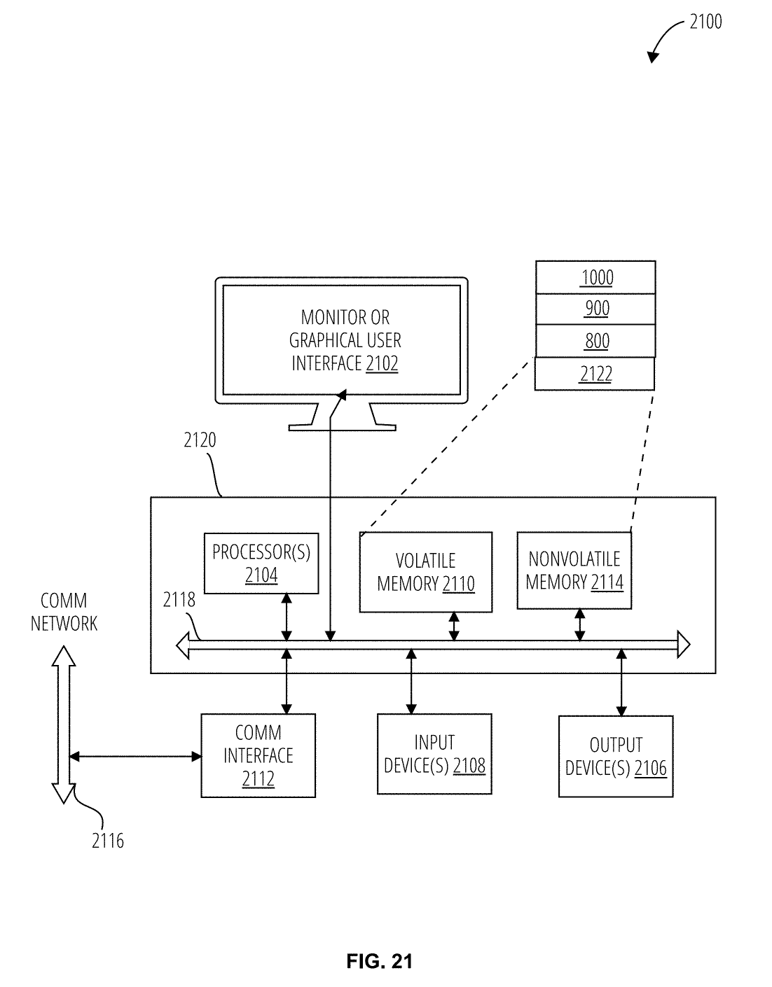

The system for automating data movement and infrastructure 600 is merely one example of how the processes described herein may be implemented by logic in a data processing system, e.g. system 2000 of FIG. 20, and computing device 2100 of FIG. 21.

In the system for automating data movement and infrastructure 600 the parser 606 retrieves raw data 604 from data sources 602 configured by the orchestration logic 626 and parses the bulk data to extract metadata before transferring the bulk data to the core data storage 636 for storage. The metadata storage 610 stores the metadata extracted by the parser 606 in a metadata index 614. The core data storage 636 stores raw data that has been parsed for metadata in data containers 638. In some configurations, the parser 606 may pull the metadata (e.g., table ranges, schema, etc.,) from raw data in the data sources 602 an receive configurations from the orchestration logic 626 identifying specific raw data (e.g., data containers) to move to the core data storage 636. In the aforementioned configuration, the parser may also function as a selector.

The refinement engine UI 612 receives user inputs to configure the operations to the refinement engine 622. The refinement engine UI 612 configures the orchestration logic to transfer particular raw data from data sources to the core data storage based on the metadata index. The refinement engine UI 612 configures the orchestration logic 626 to transfer the particular raw data to the core data storage 636 at a predetermined interval. The refinement engine UI 612 configures the orchestration logic 626 to transfer a subset of the particular raw data to the core data storage 636 at a predetermined interval. The refinement engine UI 612 configures the refinement engine 622 to transform particular data sets from the core data storage 636 into the processed data based on the metadata index 614. The refinement engine UI 612 configures the schema editor 632 to generate a particular refined data structure for the particular data sets.

The refinement engine 622 performs operations to extract data from core data storage and store in a refined data structure 642 in the refined data storage 640 as processed data 644. The orchestration logic 626 configures the selector 618 to extract data (e.g., data fields, data type, etc.,) based on the metadata stored in the metadata index 614. The orchestration logic 626 may configure the selector 618 to extract certain data based on extraction settings utilized stored in a global management infrastructure database 624.

The correlator 628 receives extracted data from the selector 618 and maps the raw data stored in the refined data structure 642 to processed data 644 according to associations in the mapping table 630. The schema editor 632 utilizes metadata index 614 to generate a refined data structure 642 in the refined data storage 640 to store the extracted data.

The schema optimization logic 634 may receive schema configurations utilized by other refined data management infrastructures on similar data to configure the schema editor 632 based on queries from a database accessor 608, lower resource intensive schema infrastructure, and frequently utilized schema structures. The schema optimization logic 634 records (e.g., as associations in the mapping table 630) the resources utilized and the schema implemented by the schema editor 632.

In some configurations, the schema optimization logic 634 suggests configurations settings to a user configuring their data movement through the refinement engine 622 based, in part, to similarities in the the data sources 602, data containers 638, particular raw data, and particular data sets, as well as other configurations detected by the system. The system may suggest a particular schema configuration, data transformation, data retrieval interval, additional data set collection, and other configurations implemented by user's of the system based, in part, on the detected configurations. The suggested configurations are presented to the user based on a similarity score being above a similarity threshold. If multiple different configurations are detected the system may rank the configurations based on the number of user's currently implementing the configuration settings.

By providing new user's with suggested configurations settings, the system reduces the interaction time and system load required and utilized during an initial configuration.

The schema optimization logic 634 aggregates configuration settings for the refinement engine 622, the orchestration logic 626, and the schema editor 632 in a global management infrastructure database 624. The schema optimization logic 634 compares new configuration settings from the refinement engine UI 612 to the configuration settings stored in the global management infrastructure database 624 to determine a similarity score. The schema optimization logic 634 communicates the configuration settings to the refinement engine UI 612, in response to the similarity score of a configuration setting being above a similarity threshold.

The allocator 620 is configured by the refinement engine 622 to store the extracted data in the refined data structure 642 as processed data 644, as the extracted data is arranged in accordance with the the refined data structure 642. The schema optimization logic 634 receives the queries run on the processed data 644 in the refined data storage 640 by the database accessor 608 to determine frequently utilized queries.

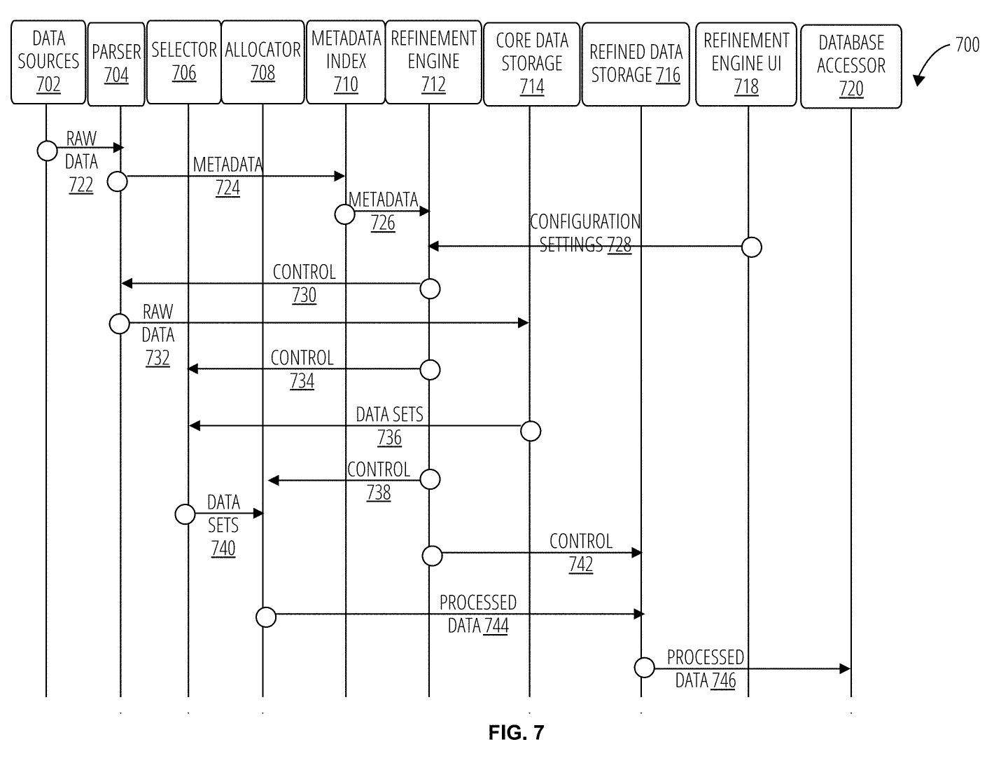

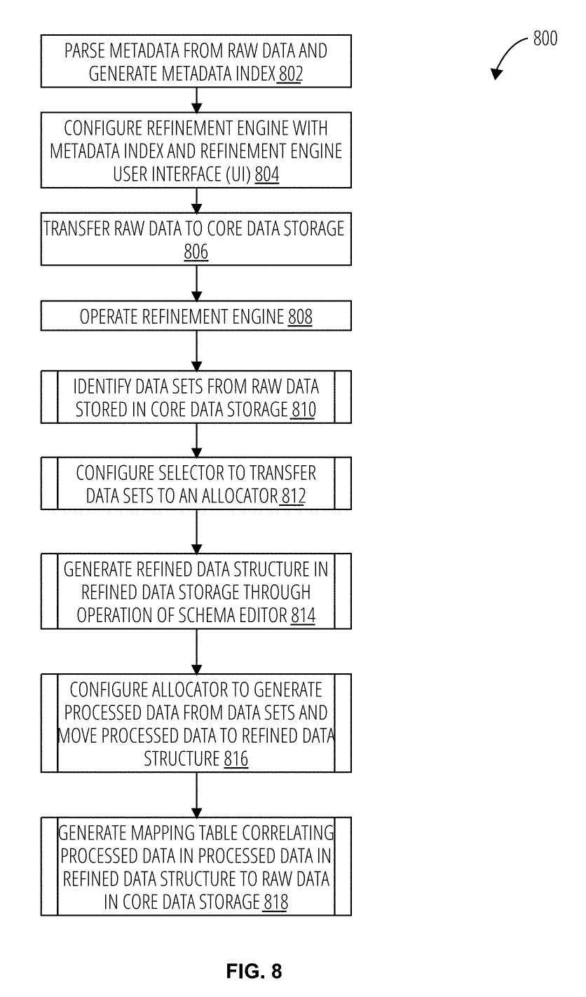

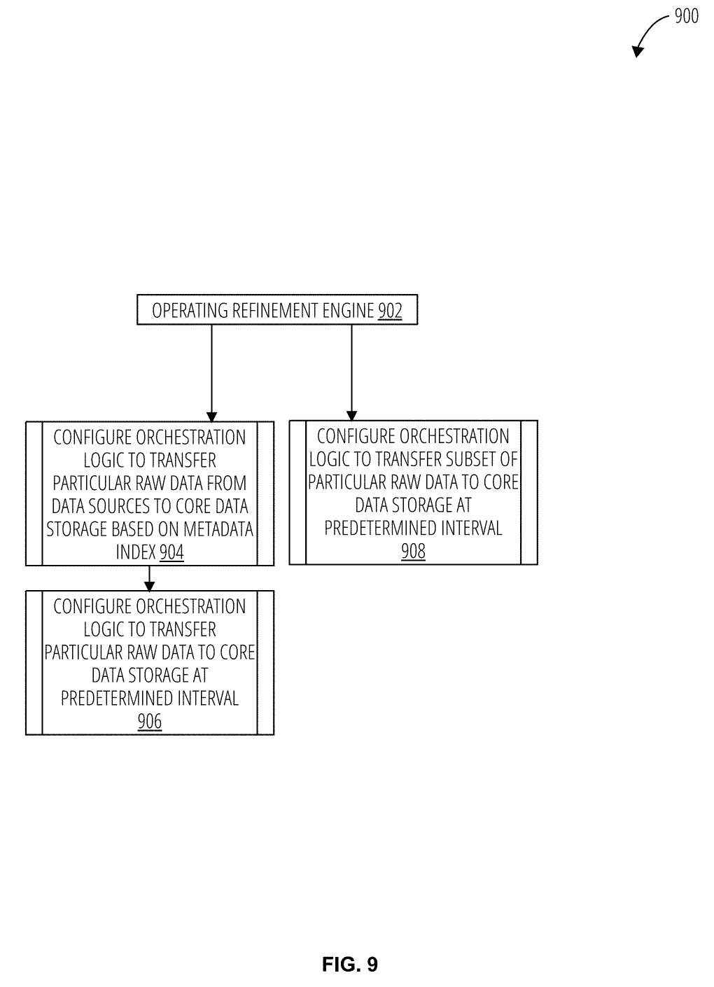

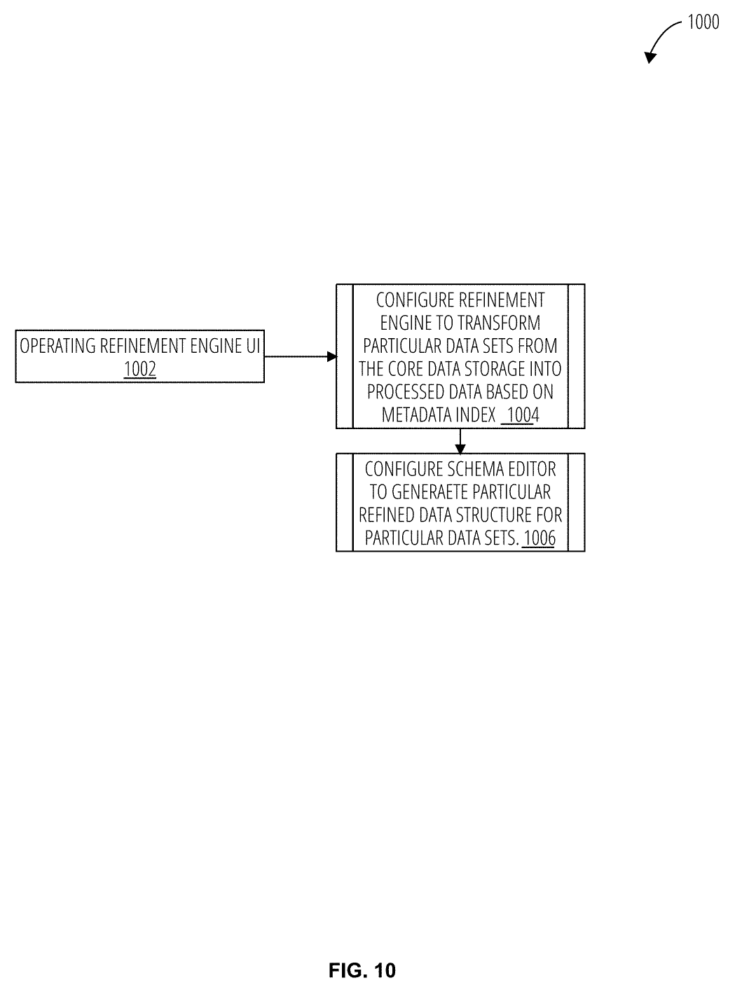

The system for automating data movement and infrastructure 600 may be operated in accordance with the processes and subprocesses described in FIG. 3, FIG. 4, FIG. 5, FIG. 7, FIG. 8, FIG. 9, and FIG. 10.

FIG. 7 illustrates a sequence diagram for a system 700 for operating a system for automating data movement and infrastructure. The system 700 comprises a data sources 702, a parser 704, a selector 706, an allocator 708, a metadata index 710, a refinement engine 712, a core data storage 714, a refined data storage 716, a refinement engine UI 718, and a database accessor 720. The parser 704 receives s raw data 722 from the data sources 702 and parses the raw data 722 for metadata 724. The parser 704 communicates the metadata 724 a metadata index 710. The refinement engine 712 utilizes metadata 726 from the metadata index 710 as parameters for the configuration settings 728 received from the refinement engine UI 718. After receiving configurations settings from the refinement engine UI 718, the refinement engine 712 communicates a control 730, generated by the orchestration logic, to the parser 704, configuring the parser 704 to move particular raw data 732 to the core data storage 714. The refinement engine 712 communicates a control 734, through the orchestration logic, to configure the selector 706 to select data sets 736 from the core data storage 714. The refinement engine 712 configures an allocator 708 through a control 738, to configure the data sets 740 received from the selector 706 to be positioned in the refined data storage 716 in a refined data structure. The refinement engine 712 communicates a control 742 to configure the refined data storage 716 through a schema editor allowing it to received processed data 744 from the allocator 708. The allocator 708 moves the processed data 744 to the refined data structure in the refined data storage 716. With the processed data 744 in the refined data structure in the refined data storage 716, a database accessor 720 is able to view data from various sources and configured in specific schemas allowing the database accessor 720 to perform data discovery and data analytics operations without additional processing load required in sorting, parsing, and formatting large raw data. This improves the efficiency and resource load allocation for the system.

Referencing FIG. 8, a method 800 of operating an automated data movement and refinement infrastructure involves parsing metadata from raw data and generating a metadata index through operation of a parser (block 802). In block 804, the method 800 of operating an automated data movement and refinement infrastructure configures a refinement engine with the metadata index and a refinement engine user interface (UI), the refinement engine comprising orchestration logic, a schema editor, a correlator, and mapping table. In block 806, the method 800 of operating an automated data movement and refinement infrastructure transfers the raw data to core data storage through operation of the parser configured by the orchestration logic. In block 808, the method 800 of operating an automated data movement and refinement infrastructure operates the refinement engine. In subroutine block 810, the refinement engine identifies data sets from the raw data stored in the core data storage. In subroutine block 812, the refinement engine configures a selector to transfer the data sets to an allocator. In subroutine block 814, the refinement engine generates a refined data structure in refined data storage through operation of the schema editor. In subroutine block 816, the refinement engine configures the allocator to generate processed data from the data sets and move the processed data to the refined data structure. In subroutine block 818, the refinement engine generates a mapping table correlating the processed data in the processed data in the refined data structure to the raw data in the core data storage through operation of the correlator.

Referencing FIG. 9, a method 900 for operating a system for automating data movement and infrastructure involves operating the refinement engine UI (block 902). In subroutine block 904, the refinement engine UI configures the orchestration logic to transfer particular raw data from data sources to the core data storage based on the metadata index. In subroutine block 906, the refinement engine UI configure the orchestration logic to transfer the particular raw data to the core data storage at a predetermined interval. Additionally, refinement engine UI configures the orchestration logic to transfer a subset of the particular raw data to the core data storage at a predetermined interval (subroutine block 908). This process operates similar to incrementally loading data on a set schedule. In this manner network, bus, and processor load balance and leveling is achieved.

Referencing FIG. 10, a method 1000 for operating a system for automating data movement and infrastructure involves operating the refinement engine UI (block 1002). In subroutine block 1004, the refinement engine UI configures the refinement engine to transform particular data sets from the core data storage into the processed data based on the metadata index. In subroutine block 1006, the refinement engine UI configures the schema editor to generate a particular refined data structure for the particular data sets.

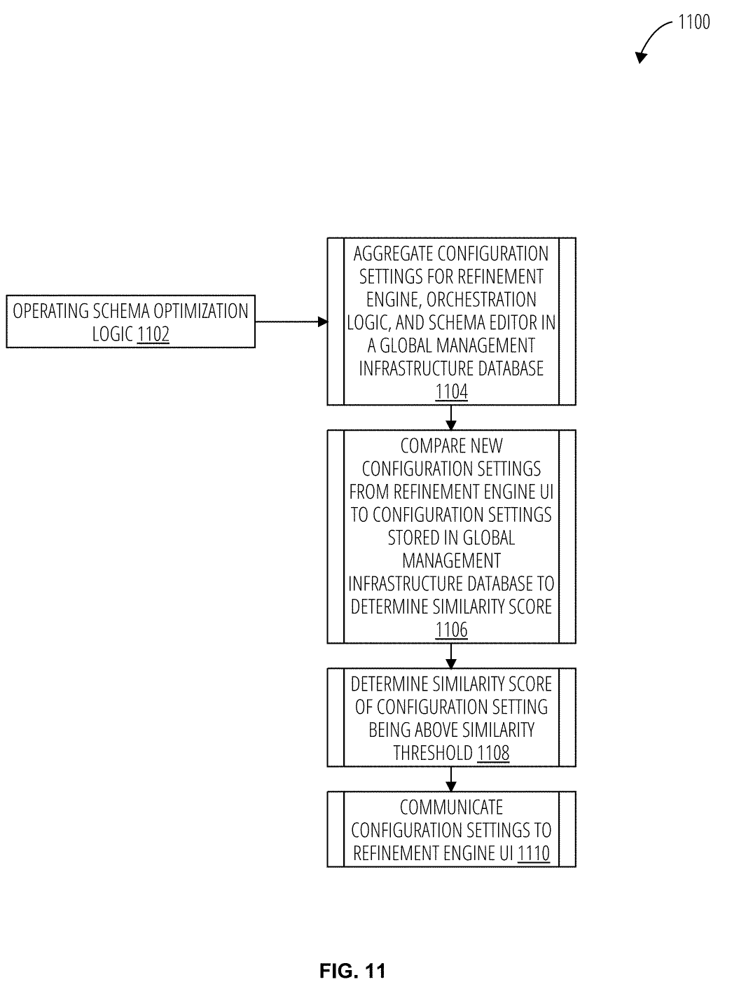

Referencing FIG. 11, the method 1100 for operating a system for automating data movement and infrastructure involves operating a schema optimization logic (block 1102). In subroutine block 1104, the schema optimization logic, aggregates configuration settings for the refinement engine, the orchestration logic, and the schema editor in a global management infrastructure database. In subroutine block 1106, the schema optimization logic compares new configuration settings from the refinement engine UI to the configuration settings stored in the global management infrastructure database to determine a similarity score. In subroutine block 1108, communicates the configuration settings to the refinement engine UI, in response to the similarity score of a configuration setting being above a similarity threshold. An example pseudo code of this process is described below:

For (configSetting.new-[configSetting.stored1, configSetting.stored2 . . . configSetting.storedn]=[similarityValue1, similarityValue2 . . . similarityValuen])

Print similarityValue( )if, similarityValue( )>similarityThreshold

In some instances, if multiple different configurations are detected the system may rank the configurations based on the number of user's currently implementing the configuration settings. By providing a ranking of configurations to the user, the system reduces the interaction time and system load required during configuration and possible reconfiguration. Although variations may exist between users, their infrastructure, and their bulk data sets, the utilization of the refined data product may be the same. As such, the configurations for refining the bulk data may share a high degree of similarities based on its functionality. By providing users with a ranked list of implemented configurations based on current usage, the system is able to provide users with a ready to implement configuration and/or an initial starting point for configuring their system, thus reducing the interaction time and system load utilized during configuration, and allowing the system to allocate these resources to meet other system demands.

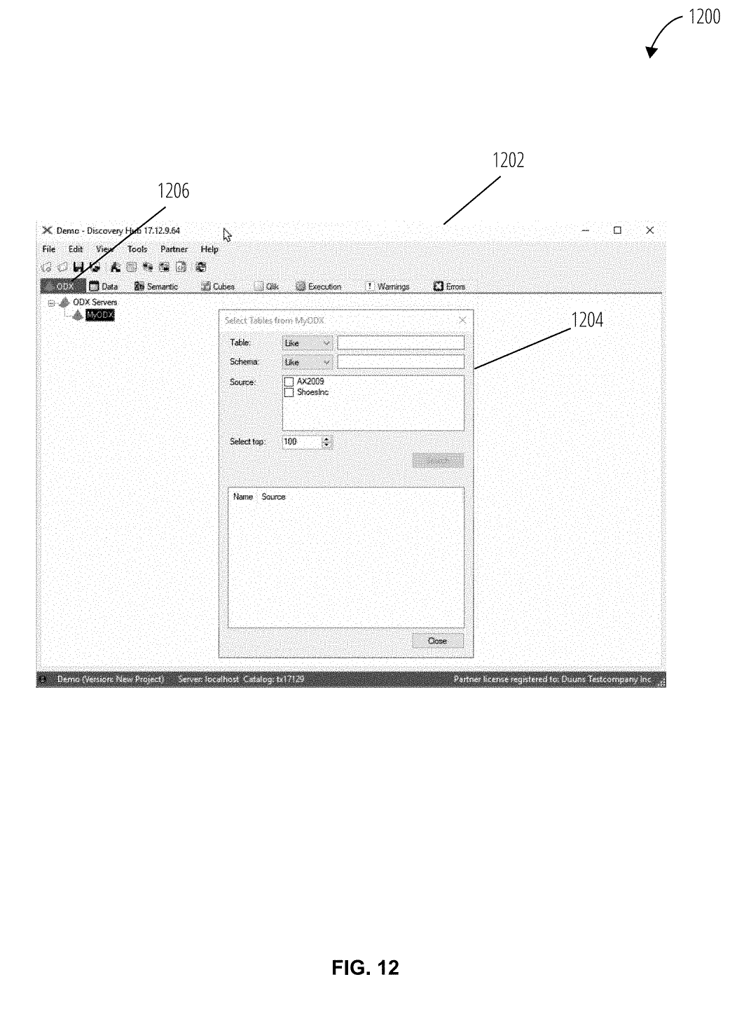

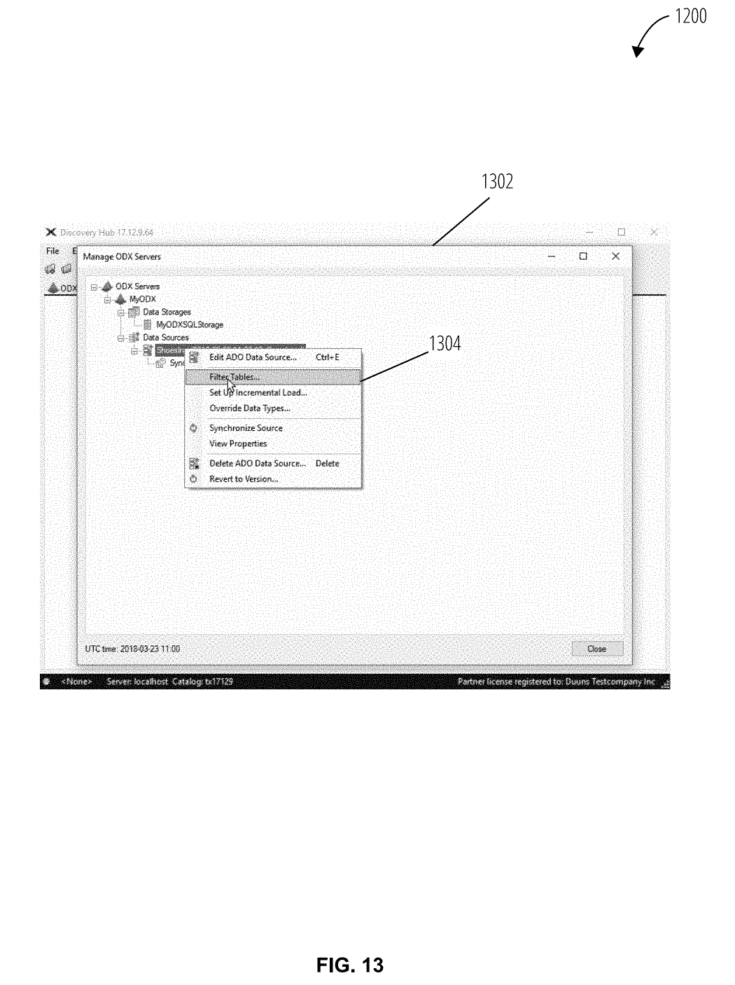

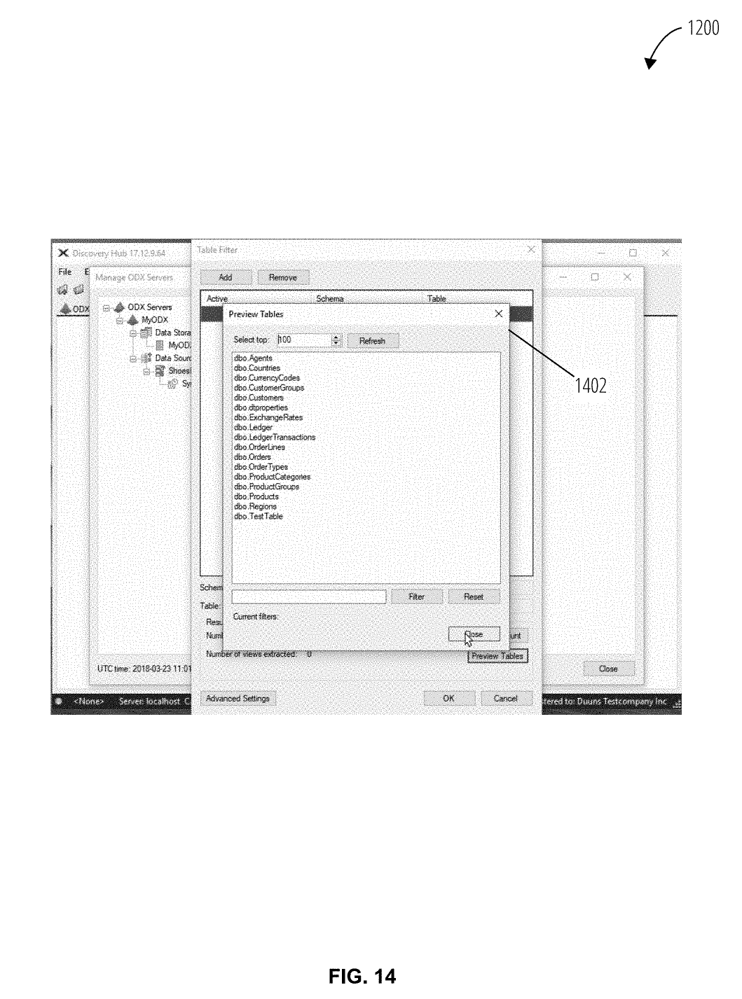

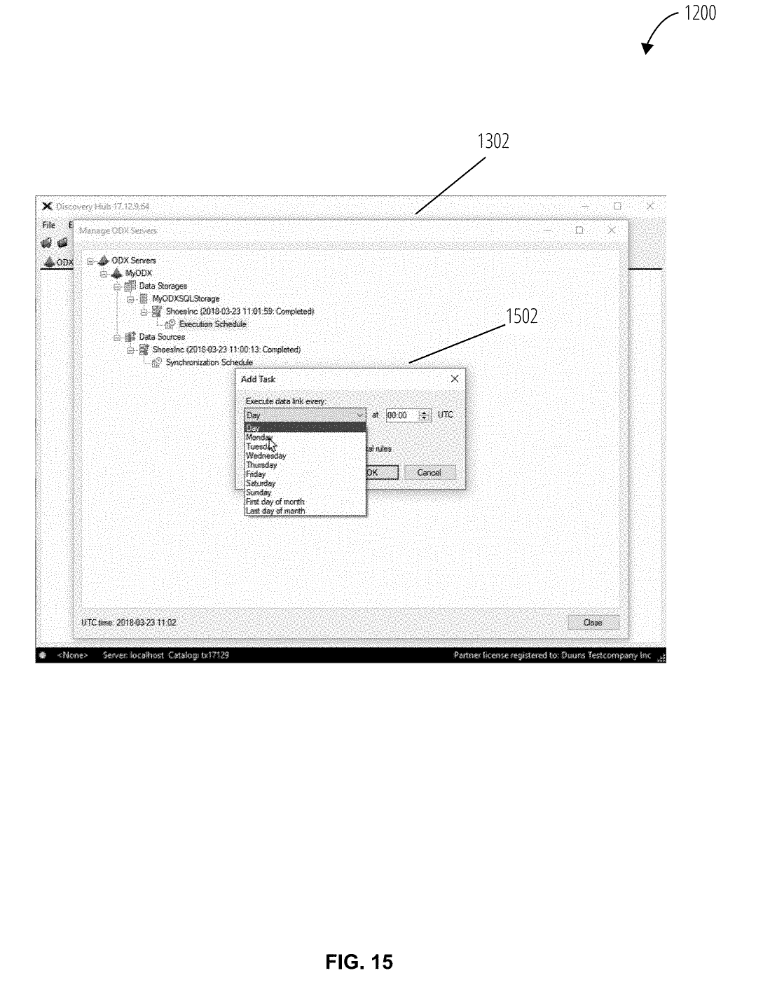

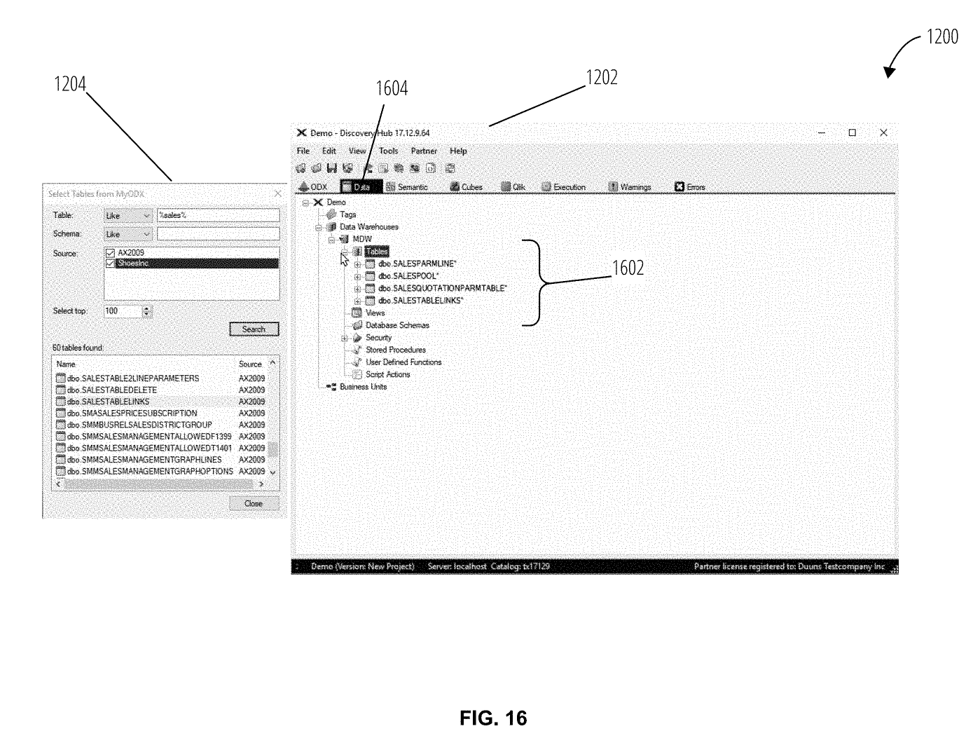

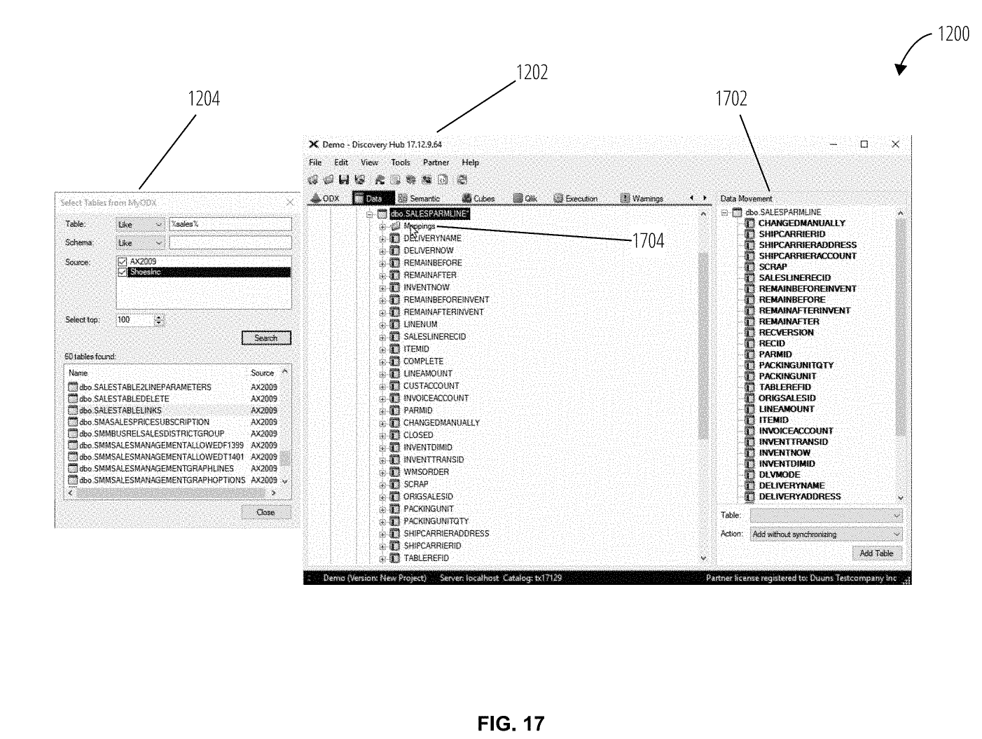

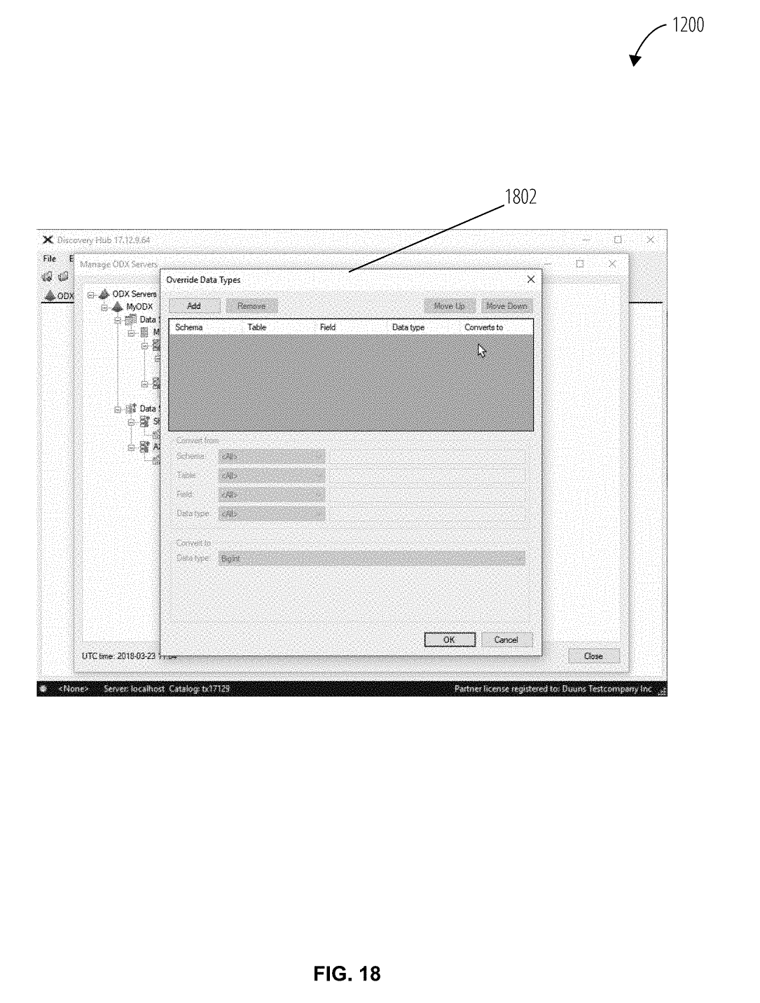

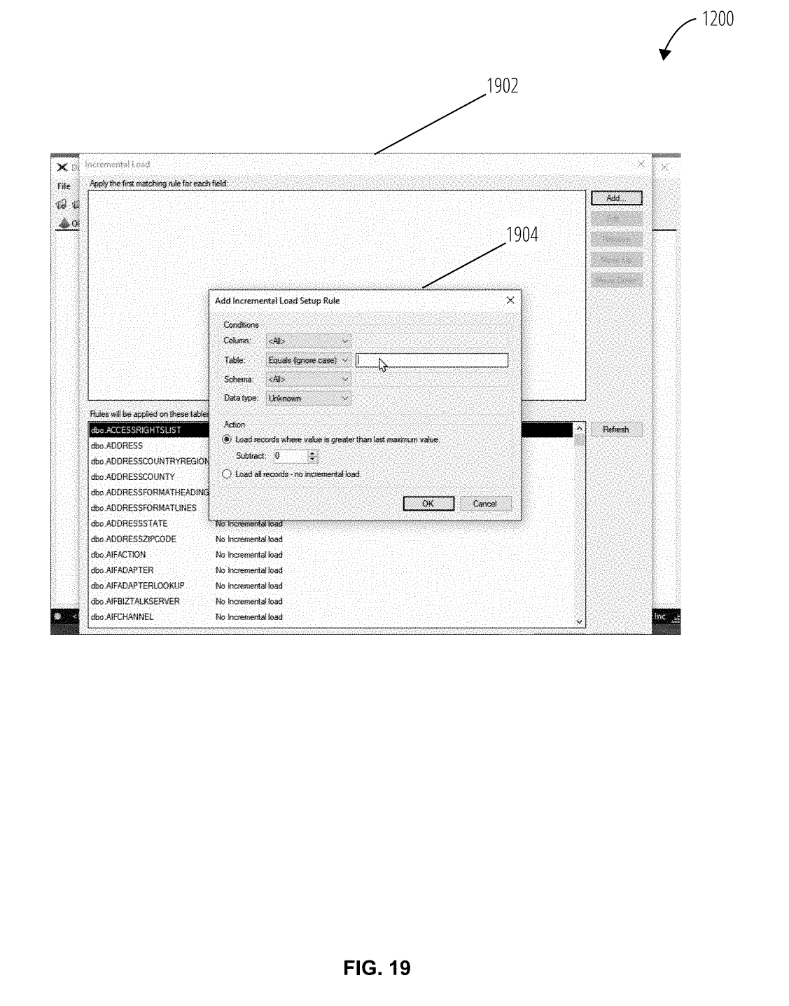

Referencing FIG. 12-FIG. 19, the refinement engine user interface 1200 comprises an infrastructure manager 1202 with a data sources menu 1206 allowing for selection of different configuration options. In FIG. 12, the data sources menu 1206 is focused on the ODX option tab which corresponds to settings related to configuring movement of raw data from data sources to core data storage. A source and table selector 1204 is shown allowing a user to select data sources as well as tables based on table names or schema. In FIG. 13, a server manager 1302 is shown allowing for the management of raw data from select sources to the core data storage. A data source options 1304 shows that an options drop down allows a user to select option such as filtering the tables of a currently selected data source. In FIG. 14, a data source preview 1402 is shown after the table filtering option is selected allowing the user to decide which tables they would like to move to core data storage, this preview is populated by the metadata index. In FIG. 15, a transfer scheduler 1502 is shown allowing a user to schedule when data is moved into core data storage. In FIG. 16, the data sources menu 1206 is shown focused on a core data storage tab 1604. The infrastructure manager 1202 shows the data stored in the core data storage such as the data containers 1602. The additionally the source and table selector 1204 may be provided allowing the user to select current sources and preview available tables to add to core data storage. In FIG. 17, the infrastructure manager 1202 shows the expansion of a table from the data containers 1602. The cursor shows a data mapping menu 1704 and a table data movement menu 1702 showing how data is allocated and configured to refined data storage. In FIG. 18, a data type configurator menu 1802 is shown allowing a user to configure the detection of data within data containers to be configured into a different type selected by the user. In FIG. 19, an incremental loader menu 1902 and a loader configurator menu 1904 is provided. the incremental loader menu 1902 allows the user to select the data from the data container (e.g., table) and a loader configurator menu 1904 that allows which fields and from which tables should be updated incrementally.

When moving data with incremental load the technology varies a bit on the destination, however, the flow and principle is the same. For example, the system may perform incremental load on data stored in an Azure Data Lake. The current incremental load may include three kind of data to move: 1) New data, 2) Updated data, and 3) Deleted data. With updated and deleted data, the system modifies existing data. In the Azure Data Lake file system it is not possible to modify existing files, although it is possible to merge existing files into a new file. In order to do this, the system must be able to read what each file contains when we transfer data, which may be done in multiple ways. This is also done while avoiding the download of each file in order to merge them with the new data as this is simply is a burden on the system and performance will be so slow negating the benefit in performing an incremental load. Instead, the system utilizes the Azure Data Lake Analytics resource which it is able to run different types of script on Azure resources. Through these analytics, the runs U-SQL scripts in the ODX and Azure runs scripts to manage the files in the Azure Data Lake. First a script provides the current incremental rule values in the existing files. This helps the system determine what data should be pulled from the data sources and uploaded to the Azure Data lake by a script merging the newly uploaded file with the existing data.

FIG. 20 illustrates several components of an exemplary system 2000 in accordance with one embodiment. In various embodiments, system 2000 may include a desktop PC, server, workstation, mobile phone, laptop, tablet, set-top box, appliance, or other computing device that is capable of performing operations such as those described herein. In some embodiments, system 2000 may include many more components than those shown in FIG. 20. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 2000 may comprise one or more physical and/or logical devices that collectively provide the functionalities described herein. In some embodiments, system 2000 may comprise one or more replicated and/or distributed physical or logical devices.

In some embodiments, system 2000 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 2000 includes a bus 2002 interconnecting several components including a network interface 2008, a display 2006, a central processing unit 2010, and a memory 2004.

Memory 2004 generally comprises a random access memory (“RAM”) and permanent non-transitory mass storage device, such as a hard disk drive or solid-state drive. Memory 2004 stores an operating system 2012.

These and other software components may be loaded into memory 2004 of system 2000 using a drive mechanism (not shown) associated with a non-transitory computer-readable medium 2016, such as a floppy disc, tape, DVD/CD-ROM drive, memory card, or the like.

Memory 2004 also includes database 2014. In some embodiments, system 2000 may communicate with database 2014 via network interface 2008, a storage area network (“SAN”), a high-speed serial bus, and/or via the other suitable communication technology.

In some embodiments, database 2014 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

FIG. 21 is an example block diagram of a computing device 2100 that may incorporate embodiments of the present invention. FIG. 21 is merely illustrative of a machine system to carry out aspects of the technical processes described herein, and does not limit the scope of the claims. One of ordinary skill in the art would recognize other variations, modifications, and alternatives. In one embodiment, the computing device 2100 typically includes a monitor or graphical user interface 2102, a data processing system 2120, a communication network interface 2112, input device(s) 2108, output device(s) 2106, and the like.

As depicted in FIG. 21, the data processing system 2120 may include one or more processor(s) 2104 that communicate with a number of peripheral devices via a bus subsystem 2118. These peripheral devices may include input device(s) 2108, output device(s) 2106, communication network interface 2112, and a storage subsystem, such as a volatile memory 2110 and a nonvolatile memory 2114.

The volatile memory 2110 and/or the nonvolatile memory 2114 may store computer-executable instructions and thus forming logic 2122 that when applied to and executed by the processor(s) 2104 implement embodiments of the processes disclosed herein. The volatile memory 2110 and the nonvolatile memory 2114 may include logic for the method 1000, the method 900, and the method 800.

The input device(s) 2108 include devices and mechanisms for inputting information to the data processing system 2120. These may include a keyboard, a keypad, a touch screen incorporated into the monitor or graphical user interface 2102, audio input devices such as voice recognition systems, microphones, and other types of input devices. In various embodiments, the input device(s) 2108 may be embodied as a computer mouse, a trackball, a track pad, a joystick, wireless remote, drawing tablet, voice command system, eye tracking system, and the like. The input device(s) 2108 typically allow a user to select objects, icons, control areas, text and the like that appear on the monitor or graphical user interface 2102 via a command such as a click of a button or the like.

The output device(s) 2106 include devices and mechanisms for outputting information from the data processing system 2120. These may include the monitor or graphical user interface 2102, speakers, printers, infrared LEDs, and so on as well understood in the art.

The communication network interface 2112 provides an interface to communication networks (e.g., communication network 2116) and devices external to the data processing system 2120. The communication network interface 2112 may serve as an interface for receiving data from and transmitting data to other systems. Embodiments of the communication network interface 2112 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 2112 may be coupled to the communication network 2116 via an antenna, a cable, or the like. In some embodiments, the communication network interface 2112 may be physically integrated on a circuit board of the data processing system 2120, or in some cases may be implemented in software or firmware, such as “soft modems”, or the like.

The computing device 2100 may include logic that enables communications over a network using protocols such as HTTP, TCP/IP, RTP/RTSP, IPX, UDP and the like.

The volatile memory 2110 and the nonvolatile memory 2114 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 2110 and the nonvolatile memory 2114 may be configured to store the basic programming and data constructs that provide the functionality of the disclosed processes and other embodiments thereof that fall within the scope of the present invention.

Logic 2122 that implements embodiments of the present invention may be stored in the volatile memory 2110 and/or the nonvolatile memory 2114. Said logic 2122 may be read from the volatile memory 2110 and/or nonvolatile memory 2114 and executed by the processor(s) 2104. The volatile memory 2110 and the nonvolatile memory 2114 may also provide a repository for storing data used by the logic 2122.

The volatile memory 2110 and the nonvolatile memory 2114 may include a number of memories including a main random access memory (RAM) for storage of instructions and data during program execution and a read only memory (ROM) in which read-only non-transitory instructions are stored. The volatile memory 2110 and the nonvolatile memory 2114 may include a file storage subsystem providing persistent (non-volatile) storage for program and data files. The volatile memory 2110 and the nonvolatile memory 2114 may include removable storage systems, such as removable flash memory.

The bus subsystem 2118 provides a mechanism for enabling the various components and subsystems of data processing system 2120 communicate with each other as intended. Although the communication network interface 2112 is depicted schematically as a single bus, some embodiments of the bus subsystem 2118 may utilize multiple distinct busses.

It will be readily apparent to one of ordinary skill in the art that the computing device 2100 may be a device such as a smartphone, a desktop computer, a laptop computer, a rack-mounted computer system, a computer server, or a tablet computer device. As commonly known in the art, the computing device 2100 may be implemented as a collection of multiple networked computing devices. Further, the computing device 2100 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method of operating an automated data movement and refinement infrastructure comprising:
parsing metadata from raw data and generating a metadata index through operation of a parser;
configuring a refinement engine with the metadata index and a refinement engine user interface (UI), the refinement engine comprising orchestration logic, a schema editor, a correlator, and mapping table;
transferring the raw data to core data storage through operation of the parser configured by the orchestration logic; and
operating the refinement engine to:
identify data sets from the raw data stored in the core data storage;
configure a selector to transfer the data sets to an allocator;
generate a refined data structure in refined data storage through operation of the schema editor;
configure the allocator to generate processed data from the data sets and move the processed data to the refined data structure; and
generate a mapping table correlating the processed data in the processed data in the refined data structure to the raw data in the core data storage through operation of the correlator.

2. The method of claim 1 further comprising:
operating the refinement engine UI to:
configure the orchestration logic to transfer particular raw data from data sources to the core data storage based on the metadata index; and
configure the orchestration logic to transfer the particular raw data to the core data storage at a predetermined interval.

3. The method of claim 2 further comprising:
operating the refinement engine UI to:
configure the orchestration logic to transfer a subset of the particular raw data to the core data storage at a predetermined interval.

4. The method of claim 1 further comprising:
operating the refinement engine UI to:
configure the refinement engine to transform particular data sets from the core data storage into the processed data based on the metadata index; and
configure the schema editor to generate a particular refined data structure for the particular data sets.

5. The method of claim 1 further comprising:
operating schema optimization logic to:
aggregate configuration settings for the refinement engine, the orchestration logic, and the schema editor in a global management infrastructure database;
compare new configuration settings from the refinement engine UI to the configuration settings stored in the global management infrastructure database to determine a similarity score; and
communicate the configuration settings to the refinement engine UI, in response to the similarity score of a configuration setting being above a similarity threshold.

6. A system to generate a refined data structure, the system comprising:
a parser to extract metadata from raw data from a plurality of data sources and to generate a metadata index distinctly stored on a metadata storage;
the parser transforming the raw data into a plurality of distinct data containers in a core data storage distinct from the metadata storage; and
a refinement infrastructure applying the data containers and the metadata index and executing orchestration logic and schema optimization logic on contents of the data containers and the metadata index to generate the refined data structure.

7. The system of claim 6, the refinement infrastructure further comprising:
a selector operable by the orchestration logic to select contents from the data containers for input to an allocator and a correlator.

8. The system of claim 6, the orchestration logic and the schema optimization logic comprising a learning function responsive to inputs from a refinement engine user interface.
